(19) United States
(12) Patent Application Publication
(10) Pub. No.: US 2019/0236387 A1
(43) Pub. Date: Aug. 1, 2019

(54) DISTRACTED DRIVING DETECTOR

(71) Applicant: NUANCE COMMUNICATIONS, INC., BURLINGTON, MA (US)

(72) Inventors: Mustafa Firik, Watertown, MA (US); Vincenzo A. Iannotti, Montreal (CA)

(73) Assignee: NUANCE COMMUNICATIONS, INC., BURLINGTON, MA (US)

(21) Appl. No.: 15/884,842

(22) Filed: Jan. 31, 2018

(51) Int. Cl. G06K 9/00; B60W 30/095; B60W 40/08; G06F 3/041

(52) U.S. Cl. CPC G06K 9/00845; G06F 3/0416; B60W 40/08; B60W 30/095

(57) ABSTRACT

Methods and apparatus for detecting a distracted user condition. In embodiments, a handheld device, such as a mobile phone, includes a distraction detection module to process sensor data and/or user date to generate a score indicative of whether the user is distracted, such as texting and driving. In embodiments, a keyboard of the device can be disabled upon detection of a distracted user condition.

### BACKGROUND

As is known in the art, distracted drivers can cause dangerous and hazardous conditions. For example, using a handheld keyboard, such as texting, while driving makes accidents significantly more likely to happen.

### SUMMARY

Embodiments of the invention provide methods and apparatus for enabling handheld devices, such as mobile phones, tablets, and the like, to detect if a person is driving and interacting with the handheld device at the same time. Embodiments should have relatively low false positive rates to minimize user frustration due to incorrect detections, such as texting by a passenger. In some embodiments, a handheld device can warn the user of distracted driving detections, such as with beeps and/or warning messages on the screen, or disable the handheld device controls, e.g., disable the keyboard.

In embodiments, a handheld device includes a detection module configured to process information from a plurality of device sensors and/or historical user information to detect a distracted driving condition. The device may differentiate a driver from passengers so that passengers will not be impacted by false positive detections. A front camera of the handheld device can monitor user eye and head movements to determine if eyes are alternating between the screen and the road, for example. Information from a variety of sensors can be processed and weighted to determine whether a distracted driving condition exists.

In one aspect, a method comprises: receiving sensor information including GPS data to determine whether a device under control of a user is moving relative to Earth surface; receiving sensor information including vibration levels of the device; receiving sensor information including angle orientation information for the device; receiving sensor information including first camera information for the device to detect user head and eye movement; processing the sensor information to determine a score corresponding to a likelihood of a distracted user condition; and communicating with a keyboard module of the device to modify at least one setting for operation of a keyboard controlled by the keyboard module.

A method can include one or more of the following features: receiving sensor information including data from a first camera of the device and processing eye movement of the user, receiving sensor information including touch and type information for a user typing on the keyboard of the device, processing the touch and type information to determine whether the user is one-hand typing or two-hand typing on the keyboard, processing the touch and type information for error rate comparison, processing the touch and type information for finger surface area on the keyboard, processing the touch and type information for speed of typing comparison, processing historical driving information for the user including time of day historical driving information, receiving sensor information including local wireless connection information, receiving sensor information including second camera information from the device that includes light level, receiving sensor information including data from a proximity sensor of the device, receiving sensor information including data from a light sensor of the device, receiving sensor information including data for a number of other nearby devices, receiving sensor information including acoustic information detected by the device to determine a number of persons in the vehicle, receiving sensor information including face and behavior information of the user, generating a signal for an audible alert corresponding to the score corresponding to a likelihood of a distracted user condition being above a selected threshold, and/or modifying at least one setting for operation of a keyboard controlled by the keyboard module including disabling the keyboard.

In another aspect, an article comprises: a non-transitory computer-readable medium having stored instructions that enable a machine to perform: receiving sensor information including GPS data to determine whether a device under control of a user is moving relative to Earth surface; receiving sensor information including vibration levels of the device; receiving sensor information including angle orientation information for the device; receiving sensor information including first camera information for the device to detect user head and eye movement; processing the sensor information to determine a score corresponding to a likelihood of a distracted user condition; and communicating with a keyboard module of the device to modify at least one setting for operation of a keyboard controlled by the keyboard module.

An article can further include instructions for one or more of the following features: receiving sensor information including data from a first camera of the device and processing eye movement of the user, receiving sensor information including touch and type information for a user typing on the keyboard of the device, processing the touch and type information to determine whether the user is one-hand typing or two-hand typing on the keyboard, processing the touch and type information for error rate comparison, processing the touch and type information for finger surface area on the keyboard, processing the touch and type information for speed of typing comparison, processing historical driving information for the user including time of day historical driving information, receiving sensor information including local wireless connection information, receiving sensor information including second camera information from the device that includes light level, receiving sensor information including data from a proximity sensor of the device, receiving sensor information including data from a light sensor of the device, receiving sensor information including data for a number of other nearby devices, receiving sensor information including acoustic information detected by the device to determine a number of persons in the vehicle, receiving sensor information including face and behavior information of the user, generating a signal for an audible alert corresponding to the score corresponding to a likelihood of a distracted user condition being above a selected threshold, and/or modifying at least one setting for operation of a keyboard controlled by the keyboard module including disabling the keyboard.

In a further aspect, a device comprises: a processor and a memory; a distraction detection module to receive sensor information including GPS data to determine whether a device under control of a user is moving relative to Earth surface, wherein the distraction detection module is configured by the processor and the memory to receive sensor information including vibration levels of the device from a gyro module, to receive sensor information including angle orientation information for the device, to receive sensor information including first camera information for the device to detect user head and eye movement, to process the sensor information to determine a score corresponding to a likelihood of a distracted user condition; and a keyboard module coupled to the distraction detection module for receiving the score corresponding to a likelihood of a distracted user condition, wherein the keyboard module is configured to modify at least one setting for operation of a keyboard controlled by the keyboard module.

A device can further include one or more of the following features: receiving sensor information including data from a first camera of the device and processing eye movement of the user, receiving sensor information including touch and type information for a user typing on the keyboard of the device, processing the touch and type information to determine whether the user is one-hand typing or two-hand typing on the keyboard, processing the touch and type information for error rate comparison, processing the touch and type information for finger surface area on the keyboard, processing the touch and type information for speed of typing comparison, processing historical driving information for the user including time of day historical driving information, receiving sensor information including local wireless connection information, receiving sensor information including second camera information from the device that includes light level, receiving sensor information including data from a proximity sensor of the device, receiving sensor information including data from a light sensor of the device, receiving sensor information including data for a number of other nearby devices, receiving sensor information including acoustic information detected by the device to determine a number of persons in the vehicle, receiving sensor information including face and behavior information of the user, generating a signal for an audible alert corresponding to the score corresponding to a likelihood of a distracted user condition being above a selected threshold, and/or modifying at least one setting for operation of a keyboard controlled by the keyboard module including disabling the keyboard.

### BRIEF DESCRIPTION OF THE DRAWINGS

The foregoing features of this invention, as well as the invention itself, may be more fully understood from the following description of the drawings in which:

FIG. 1A is a front view of a handheld device having distraction detection and FIG. 1B is a back view of the device of FIG. 1A;

FIG. 2A is a representation of a handheld device in a vehicle while not being used by a driver and FIG. 2B is a representation of a handheld device in a vehicle with the driver using the device keyboard, and FIG. 2C shows an example device angle position;

FIG. 3 is a flow diagram of an example sequence of steps for determining a distracted situation;

FIG. 4 is a flow diagram showing an example sequence of steps for processing sensor and other information to make a distraction detection determination;

FIGS. 5A-5D are a tabular representation of example sensor data with example weighting; and

FIG. 6 is a schematic representation of an example computer that can perform at least a portion of the processing described herein.

### DETAILED DESCRIPTION

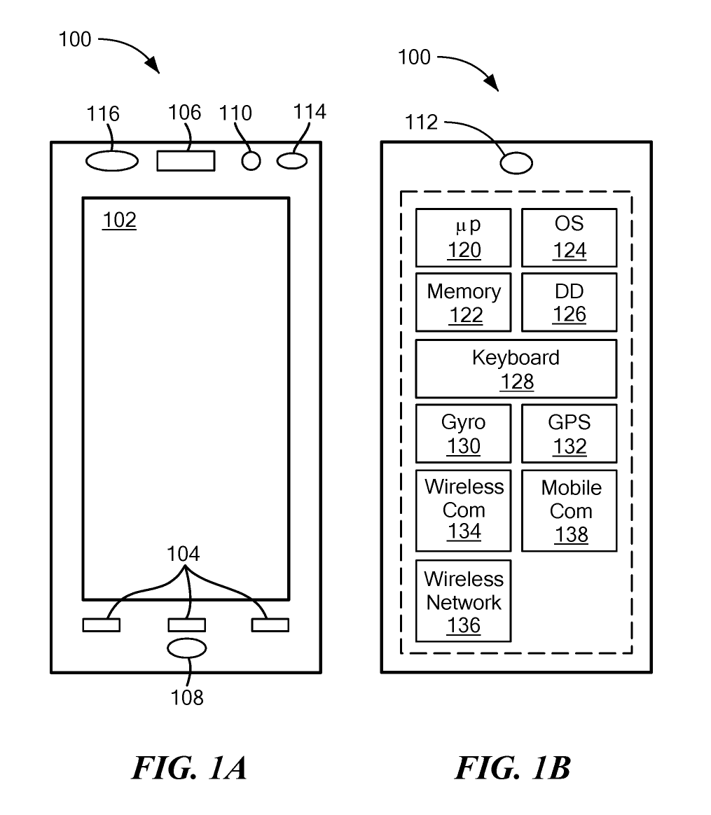

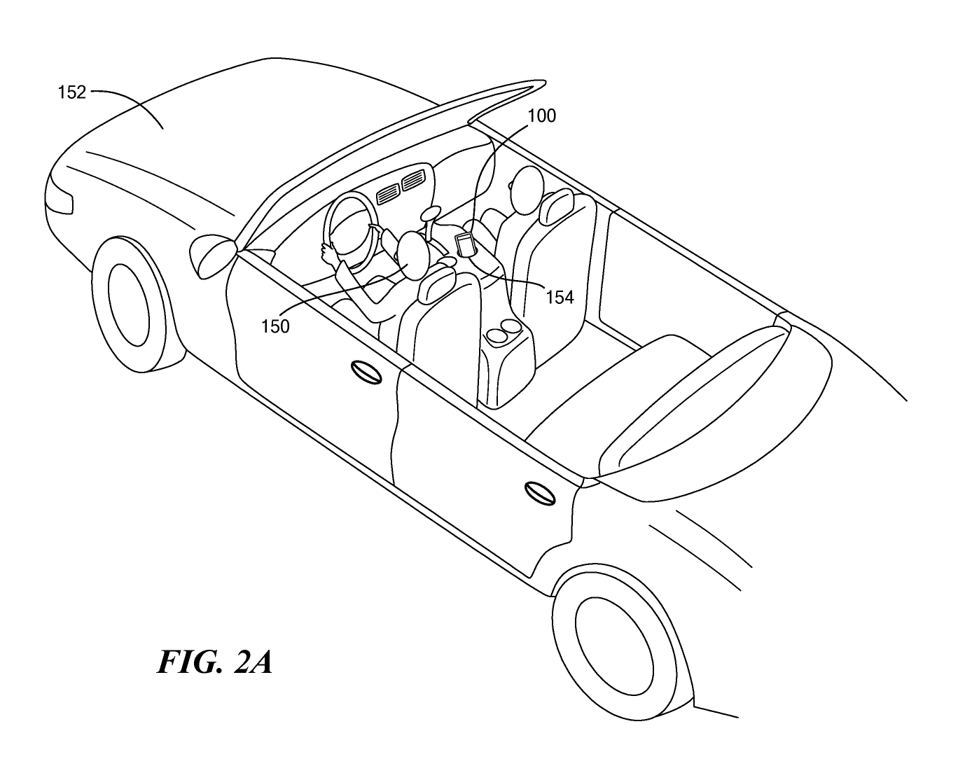

FIG. 1A (front view) and FIG. 1B (back view) show an example device 100 having sensors, user interface controls, and components that enable processing of sensor data and/or user data to determine whether a distracted driving condition exists, such as texting and driving. In an illustrative embodiment, the device 100 is provided as a handheld device, such as a mobile phone.

In embodiments, the device 100 includes a display 102, such as a touch screen, user interface buttons 104, one or more speakers 106 and a microphone 108. The device 100 can include a front camera 110 and a back camera 112. Without limiting embodiments of the invention to any particular configuration, it is understood that front and back are relative terms and that the front camera 110 can be considered the camera that faces the user in normal use.

The device 100 can include a light sensor 114 and a proximity sensor 116 each of which can be located in any practical position on the device. Information from the light sensor 114 and proximity sensor 116 are described more fully below.

The device 100 includes a processor 120 coupled to memory 122 both of which are supported by an operating system 124. In embodiments, the device 100 includes a distraction detection module 126 coupled to the processor 120 and the memory 122. A keyboard module 128 is coupled to the distraction detection module 126, as well as the processor 120. The distraction detection module 126 can detect a distracted user condition, such as texting and driving, and communicate with the keyboard module 128 to modify or disable device keyboard functionality, as described more fully below.

The device 100 can include a gyro sensor module 130 and a GPS module 132. In embodiment, the device 100 includes a close proximity wireless communication technology, e.g., BLUETOOTH, module 134, a wireless network communication, e.g., Wi-Fi, module 136, and a mobile communication module 138.

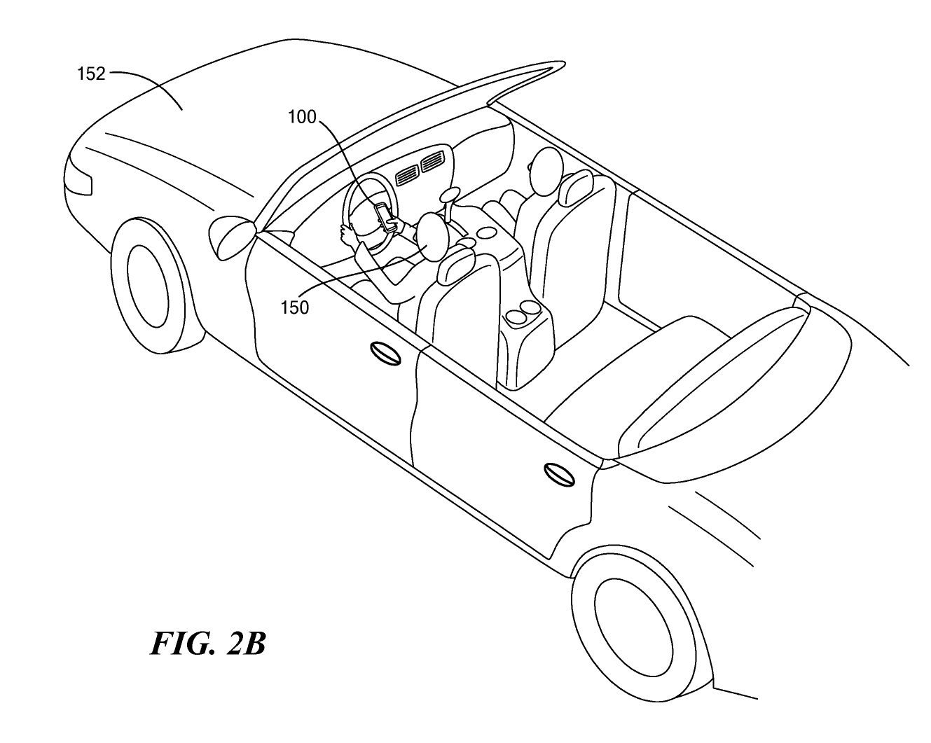

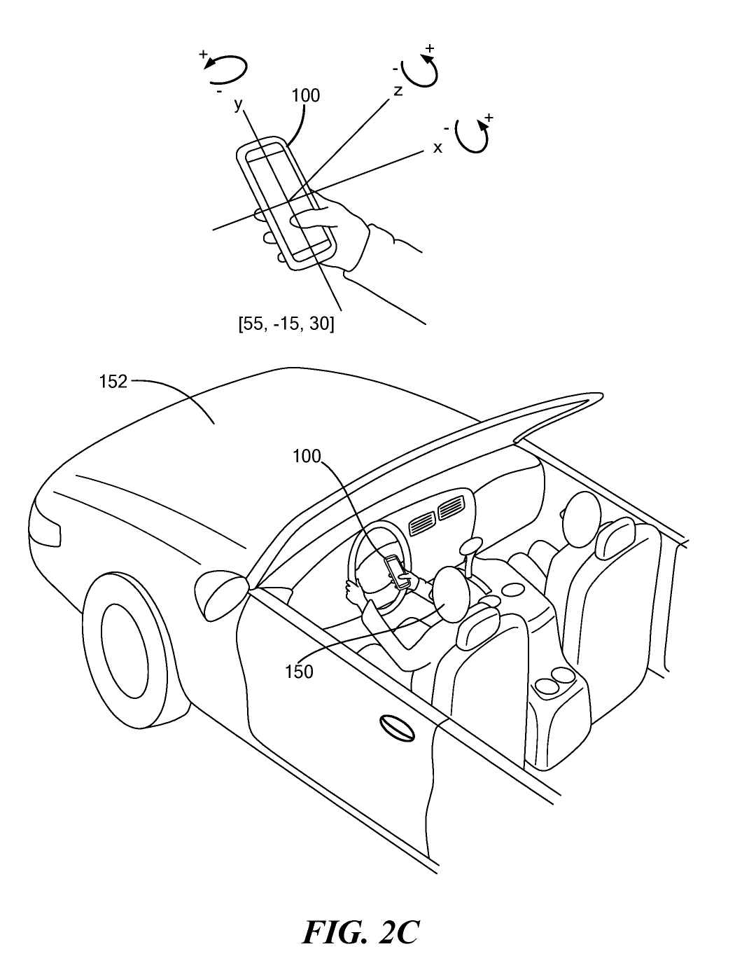

FIG. 2A shows a handheld device 100 and the user 150, shown as the driver, during safe operation of a vehicle. In the illustrated embodiment, the device 100 is located in a cupholder 154 in the console area of the vehicle. In general, sensor data will be indicative of a non-distracted driving operation, as described more fully below.

FIG. 2B shows the handheld device 100 in the vehicle 152 when the driver 150 is texting and driving. In embodiments, the gyro sensor 130 can provide angle information, e.g., the angle of the handheld device when user is safely operating the device, such as the device being in a vehicle cupholder or texting on a couch, and unsafely operating the device, such as texting and driving. The gyro sensor 130 can also provide vibration information to detect when the handheld device 100 is stationary/idle, e.g., in a vehicle cupholder 154, and when the device 100 is being actively used by the user.

FIG. 2C shows an example frame of reference and angle information for a device 100 having, x, y, z axes based on the figure. The way x, y, z is calculated could be different depending on the device. In the illustrated position, gyro sensor 130 outputs an angle position in x,y,z coordinates as [55, −15, 30] where reference position is [0, 0, 0] when the phone is flat and oriented in a given position. It is understood that any suitable reference frame and coordinate type can be used to meet the needs of a particular application.

Referring again to FIGS. 1A and 1B, in embodiments, the gyro sensor 130 detects angle of the device 100 in the vehicle including when the driver is holding the device. The angle and acceleration of the mobile device 100 can suggest a positive case indicative of texting and driving. That is, the angle and peak and average acceleration of a device 100 during texting and driving is usually different than non-texting and driving conditions of the same user in order to accommodate steering wheel position and multitasking needed to continue driving at the same time, as shown in FIGS. 2A and 2B. Also, angle of the phone 100 and peak and average vibration will likely be also different between times when the user is driving the car and when in the passenger seat or texting on a couch.

Gyro-accelerometer sensor 130 data can also be used to examine moving and typing patterns. Most drivers who text and drive start texting when the car stops at a traffic light, and they stop typing when car starts moving again. Gyro-accelerometer 130 data and touch and type data can be used together to indicate driving situations.

Another sensor data that may be utilized for detecting unsafe operation is the vibrations detected by the gyro sensor (gyroscope-accelerator combo sensor) 130. For example, many text-and-drivers keep their phone 100 in the vehicle cup holder 154 or other location when not using the device. When in such a location, the phone 100 is typically subject to more vibration and impacts due to road conditions. Passengers are less likely to place a device or phone in a cup holder or similar location.

In one scenario, a device is idle and the screen is locked. Upon unlocking of the screen by the user, the distraction detection module 126 can collect sensor information. For example, the distraction detection module 126 can examine sensor information to determine whether the device is in a pocket or a bag. If so, then the distraction detection module 126 will generate a score indicative of a non-texting and driving situation. For example, in a user's pocket, the device can be at any angle but will be subject to low vibration levels because there are several shock absorbers for the device, such as the seat, user's body, clothes, etc. The sensor data for the proximity sensor, light sensor, cameras, etc., will also be indicative of being in a pocket or bag. Where the device 100 is in a cup holder, the device can be at angle but will likely experience relatively high vibration levels. However, if the device is flat on its front or back surface, it is unlikely the device is in a pocket.

In another example, the device 100 may be held by a user with the screen unlocked. For a driver, vibration may not be a heavily weighted factor while the device angle may be weighted heavily along with how frequently the angle changes and with what acceleration. In general, most drivers hold the phone differently than when they are not driving and they change angle as they stop and go, or when they see a law enforcement person, for example. For a passenger, vibration levels may not be of particular interest while the angle of the device may be of interest.

The front camera 110 can detect movements of user head and eyes. In embodiments, the eyes and head of the user may alternate between the screen of the mobile device 100 and straight ahead towards the windshield (FIGS. 2A and 2B). If the user view alternates between the device 100 and the windshield above a threshold amount, e.g., more than 3 switches in a 5 second window, a texting and driving situation may be indicated.

The front camera 110 and back camera 112 can detect the light level in lumens. For example, the light levels between (a) the user outside of a car, (b) in a passenger seat, and (c) in the driver seat will be different due to physical characteristics of the environment, since typically less light exists in the driver seat due to steering wheel than front passenger seat. The same approach applies to camera focus data calculating distance, as the driver's handset device will have a shorter distance to the next object because the steering wheel or main console will be very close by. Light level and focus data may be used to indicate driving situation. It is understood that light levels detected by the device cameras 110 and 112 as well as the light sensor 114 may be used for the same purpose.

The proximity sensor 116 detects if an object is close to the device and can be useful for detecting two hand typing, as described more fully below. It is understood that single hand typing may be indicative of a text and driving situation, although some users may be able to drive and type with two hands. The sensor data source to detect two hand typing includes keyboard touch and type and proximity sensor complements it to further reduce false positives and false negatives.

In embodiments, wireless communication information can be used to determine whether a distracted driving condition may exist. For example, based on the available networks, such as BLUETOOTH connections, and the names of the networks, the wireless communication module 134 can determine whether a user is a driver or in a public location, such as a bus or other public transportation. If a relatively high number of BLUETOOTH connections are detected, this may be indicative of a non-driving situation. In addition, network names may be suggestive of a personal vehicle and may be indicative of a user being a driver. In addition, the number of times a user has connected to a given network may also be taken into account by the wireless network module 136 in determining whether a distracted driving condition exists. In embodiments, a device protocol, such as for IPHONE or ANDROID systems, may be used by the mobile communication module 138 to determine that the user is in a public transportation environment where there are many nearby phones.

Statistical and historical data can also be used by the distraction detection module 126 to determine whether a distracted driving situation may exist. For example, time of the day information shows that the driver usually drives 9-10 AM and 6-7 PM on weekdays. Based on the current time and date, the driver is likely in the vehicle which can be used as a factor in determining whether a distracted driving condition exists.

Keyboard touch and type information, using a device 100 touch screen 102 and keyboard application, can also be used to determine if a distracted driving condition exists. For example, if typing on the keyboard is a single hand operation then this may be indicative of a distracted driving condition since most users can only drive and text with one hand. It should be noted that some users can drive and use both hands on the keyboard to type at the same time. One hand typing versus two hand typing can be detected by observing the speed of touching the keys. Two hand typing will likely touch non-adjacent keys significantly faster than one hand as there will be extra delay caused by thumb moving from one key to another. The gyro-accelerometer sensor 130 can also act as a supplemental data to detect if the device is held on portrait or landscape position. Landscape position very likely means this is a two-hand typing situation, hence it is less likely a driving situation, although some drivers can text and drive using two hands.

In addition, a number of typing errors and deletion rate can be compared to averages for a given user. A relatively high error rate can be indicative of texting while driving. Such processing can be performed by the distraction detection module 126.

In embodiments, a surface area of the touch of the fingers can be compared to averages for a given user. In a driving situation, due to multitasking, user fingers will typically touch a larger surface area on the touch screen 102 than non-driving situation.

In embodiments, the typing speed and/or the time it takes for each touch of the keyboard can be taken into account. For example, significantly slower than average type speed can be indicative of a distracted driving condition. Additionally, the touch time, which is the time between a finger touched the screen and lifted, will likely be more for the driving situation. In embodiments, such processing can be performed by the distraction detection module 126.

In some embodiments, a car sensor, such as a seat pressure sensor, can determine whether a driver and/or passenger is present in the vehicle. This information can be used to determine whether the user is a driver and alone in the car. For example, if the car sensor tells the handset device there is no passengers in the car except the driver, then the user of the handset device is very likely the driver.

In embodiments, acoustic information from the vehicle or device microphone can be processed to determine whether conversation are taking place. If there is conversation between two or more people in the vehicle, it will imply the user of the handset device could be a driver or passenger, however, if there is no conversation detected then it is very likely there is only one person in this car who is the driver, so it is a text and drive situation. The acoustic information will be more reliable if it can use voice biometrics to differentiate a real conversation happening in the vehicle from a conversation on the radio or a monologue.

In embodiments, the front camera 110 can analyze a user's face and/or behavior, age, gender, mood, and other face attributes in determining whether a distracted driving condition exists. For example, certain age and gender groups could have statistically higher likelihood of text and driving. Additionally, user's face attributes and mood may be used to further understand whether this is a driving condition. For example, if the user's eye brows look significantly different than in the same user's historical safe texting, i.e. raised eye brows, this may indicate texting and driving.

In an example scenario a user is driving a car and typing with the keyboard of a device 100, such as a smartphone. Typing on the keyboard can be intended for text messaging, entering a web address into the browser, etc. The distraction detector module 126 receives location data (GPS, Wi-Fi, cellphone tower triangulation) for the device and determines that the device is moving faster than a speed threshold, such as 20 miles per hour, which indicates that the device is in a moving vehicle. At this point, it is understood that a driver or a passenger can be using the device.

The distraction detector 126 collects sensor and/or historical information for the user and generates a score indicating whether it is likely the user of the device is in a distracted driving situation or not.

While example embodiments of the invention are shown and described in conjunction with texting and driving it is understood that embodiments of the invention are applicable to detecting distracted situations in general, such as walking and texting, for example, in a city with heavy traffic and many objects. In such applications, sensor information baseline information can be adjusted for detecting walking and texting.

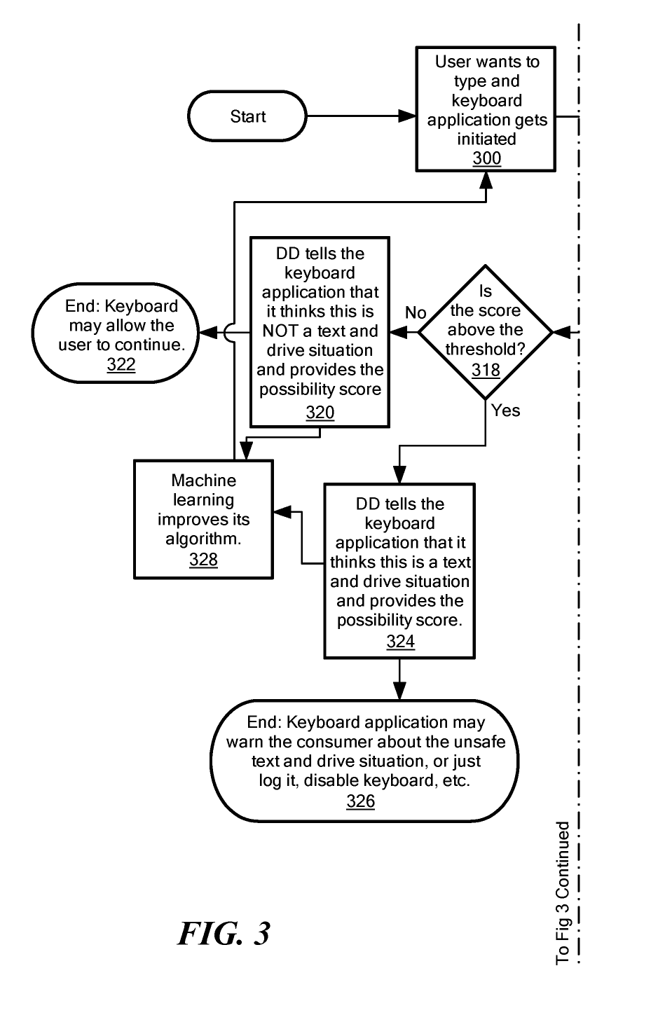

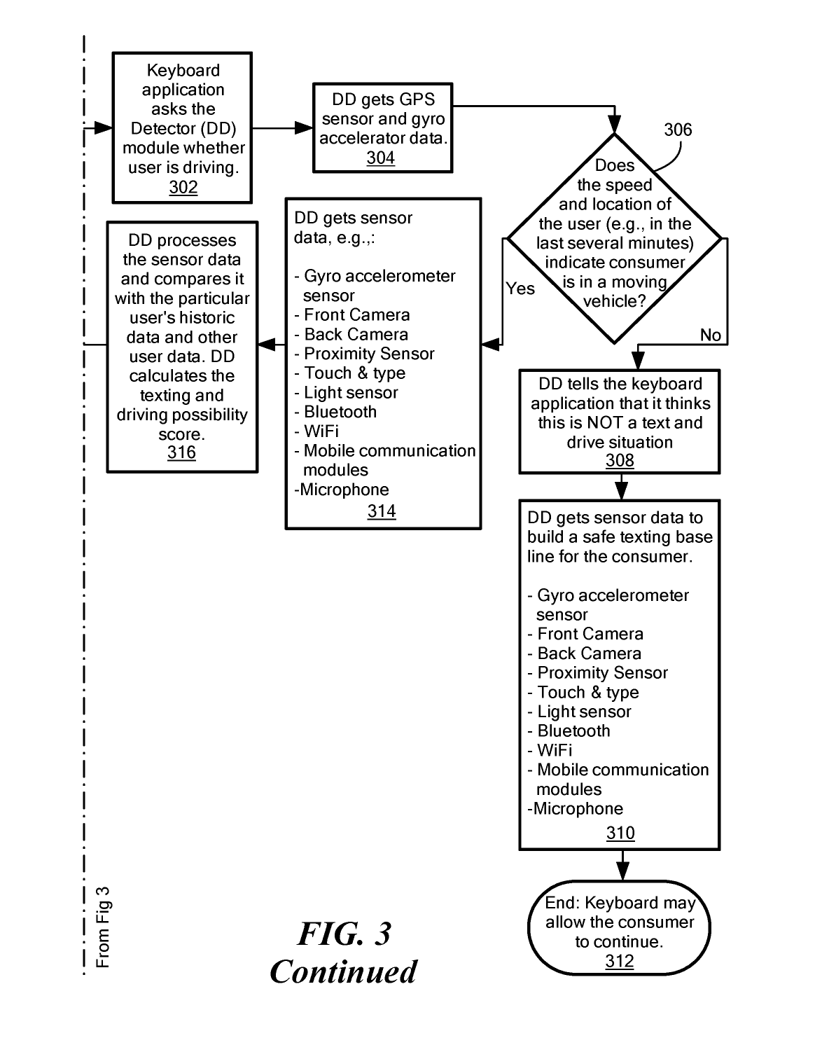

FIG. 3, in conjunction with FIGS. 1A and 1B, show an example sequence of steps for determining a distracted user condition and communicating with a keyboard application of a handheld device. In step 300, a user wants to type on the keyboard of the handheld device so that the keyboard module 128 is initiated to interface with the user, for example by touchscreen. In step 302, the keyboard module communicates with the distraction detection module 126 to ascertain whether the user is driving. In step 304, the distraction detection module 126 receives information from the gyro sensor module 130 including device acceleration data. In step 306, it is determined, such as by the distraction detection module 126, whether the speed and location, such as from a GPS module 132, indicate that the user is in a moving vehicle. The speed and location data can correspond to a desired time interval, such as the last five minutes. If not, in step 308, the distraction detection module 126 communicates with the keyboard module 128 indicating that a distracted driving condition does not exist, e.g., a driving and texting situation is not present. In optional step 310, the distraction detection module 126 can obtain sensor data to build or update a safe condition baseline. For example, sensor data for the various sensors, such as gyro, front and back cameras, proximity sensor, touch and type, light sensor, wireless communication, wireless network, and sound information can be updated for a safe driving condition. In step 312, the keyboard module 128 can allow the user to type on the keyboard and otherwise interface with the device.

If the user was found in step 306 to be in a moving vehicle, in step 314 the distraction detection module 126 receives sensor data and/or user data to determine a score indicative of the likelihood of a distracted user situation, such as texting and driving, in step 316. In step 318 it is determined whether the score is above a threshold. In an embodiment, a score above the threshold indicates that a determination of distracted driving is present. If the score is below the threshold, the distraction detection module 126 communicates to the keyboard module 128 that a distracted driver situation is not present. In step 322, the keyboard module 128 can allow the user to type on the keyboard.

If the score in step 318 was determined to be above the threshold, in step 324 the distraction detection module 126 can communicate to the keyboard module that a distracted driver condition is present. In embodiments, the score computed in step 316 can be provided to the keyboard module. In step 326, the keyboard module 128 can take actions in response to the distracted driver condition. Example actions include generate a warning to the user, log the sensor and/or other information, and/or disable the keyboard, etc.

In step 328, from either step 324 (text and drive situation) or step 320 (non text and drive situation), the system can perform machine learning to improve the detection of distracted user conditions with increased accuracy and decreased false positives.

In embodiments, a distraction detector can include machine learning. The device is initialized with a set of standard thresholds for the sensors (e.g., front and back camera, proximity sensor, statistical information, touch and type, light sensor, wireless connections, sound information, being monitored to detect the driving mode.

The initial information baseline is established by generating models from collecting data of users in multiple control groups. In one embodiment, control groups include a first group of users in the passenger seat of moving cars and a second group of users on a video driving and texting. From collected data, baselines are established that categorizes appropriate thresholds for the initial settings. In embodiments, initial settings are downloaded to a handheld device upon initiation of the distraction detector.

In embodiments, when the driver attempts to perform a texting operation and the system compares the settings with thresholds on the device, the system locally stores the settings and the determination of distracted driving. The settings contain a snapshot of the above settings and the determination of distracted driving along with information regarding user overrides. The device, for example when connected via a wireless network, can upload sensor and stored data to a network for further processing.

Upon receiving the uploaded data, a network application can generate threshold models for different hierarchical layers, such as global, regional, user, etc. The collected data is then compared with various the models and the model thresholds are improved as patterns emerge. If there is sufficient user-specific data, a user-specific model can be delivered to the device. If there is insufficient data to extract more refined thresholds for the user, regional thresholds can be delivered to the device with thresholds based upon regional driving patterns. Global settings can also be downloaded in the absence of more specific models.

In some embodiments, one or more cameras with a field of view including the driver's face can be used for eye and head movement tracking.

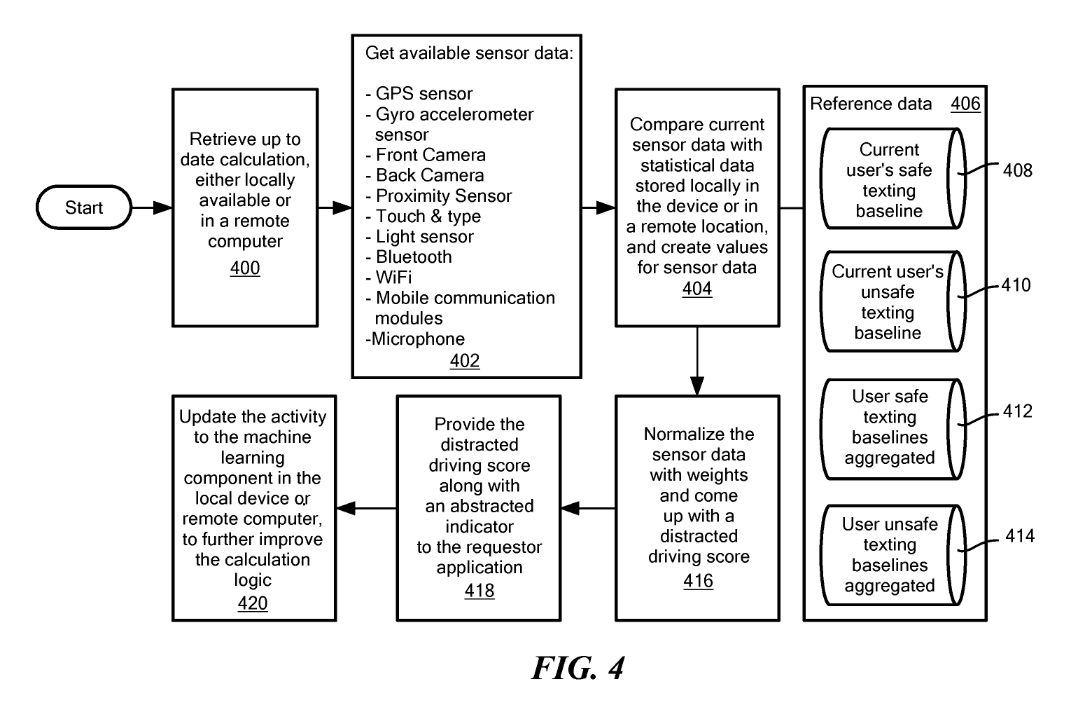

FIG. 4 shows an example sequence of steps for processing sensor information and user information for determining a distracted user condition. In step 400, a distraction detector retrieves a distraction score calculation. In step 402, the distraction detector obtains sensor information, such as some or all of the sensor data described above. In step 404, the current sensor data is compared with statistical data relating to whether a distracted driving condition exists or not. It is understood that data can be stored locally on the device, a remote location, or in a cloud-based service. As shown in 406, first data 408 can include data associated with safe device operation for a current user. Second data 410 can include data associated with unsafe device operation for a current user. Third data 412 can include data associated safe device operation for a user baseline, such as baseline data for a set of users. Fourth data 414 can include data associated with unsafe device operation for a user baseline, such as a set of users.

In step 416, the sensor data can be normalized with a desired weighting scheme to generate a score indicating whether or not a distracted driver condition exists based on the sensor and other data. In example embodiments, in step 418, the distractor detector can process the data to generate the score. A flag can be set to indicate a text and driving situation generated from a numeric score. The score and flag can be passed to a requesting application such as keyboard module.

In step 420, a machine learning module, can be updated with recent activity in order to improve the accuracy of the generated score. For example, if a score is confirmed to indicate that a distracted driver condition exists, this information can be used to improve the machine learning module. Similarly, if a score is shown to be incorrect, this information can also improve the machine learning module.

### EXAMPLES

Some example data is set forth below for a “Person 1” in a safe texting environment, user average safe texting data, average user texting and driving data, and example current data for a person.

### EXAMPLES

| | Example Control | Example Control | Example Control | |
|---|---|---|---|---|
| | Data: | Data: | Data: | |
| | Person 1 Safe | User Average Safe | Average User | Example Current |
| | Texting | Texting | Texting and Driving | Data: |
| Factor | Characteristics | Characteristics | Characteristics | Person 1 |
| Gyro Sensor | Angle = [−44, −8, −10] | Angle = [−51, −12, −14] | Angle = [−22, −22, −12] | Angle = [−32, −15, −16] |
| | Average vibration = | Average vibration = | Average vibration = | Average vibration = |
| | 0.023 g | 0.026 g | 0.078 g | 0.072 g |
| | Average | Average | Average acceleration = | Average acceleration = |
| | acceleration = 0.003 m/s2 | acceleration = 0.002 m/s2 | 0.012 m/s2 | 0.013 m/s2 |
| Front Camera | Average eye gaze | Average eye gaze | Average eye gaze | Average eye gaze |
| | alternating between | alternating between | alternating between | alternating between |
| | screen and far | screen and far | screen and far | screen and far object |
| | object (5 seconds) = | object (5 seconds) = | object (5 seconds) = | (5 seconds) = 2.6 |
| | 0.23 | 0.32 | 2.1 | |
| Back Camera | Average light level | Average light level | Average light level (5 | Average light level (5 |
| | (5 seconds) that | (5 seconds) that | seconds) that camera | seconds) that camera |
| | camera detects = | camera detects = | detects = 314 lumens | detects = 288 lumens |
| | 482 lumens | 421 lumens | Average proximity of | Average proximity of |
| | Average proximity | Average proximity | closest object = 0.3 | closest object = 0.3 |
| | of closest object = | of closest object = | meters. | meters. |
| | 2.3 meters. | 2.1 meters. | | |
| Proximity | Average occupancy | Average occupancy | Average occupancy | Average occupancy (5 |
| Sensor | (5 seconds) = | (5 seconds) = | (5 seconds) = | seconds) = |
| | 0.2/second | 0.2/second | 0.001/second | 0.002/second |
| Statistical | Average texting in | Average texting in | Current hour text | Current hour text |
| driving info | this hour, in the | this hour, in the | amount = 1.4 texts. | amount = 1.5 texts. |
| | same week day = | same week day = | | |
| | 0.2 texts. | 0.3 texts. | | |
| Touch & Type | Two hands texting = | Two hands texting = | Two hands texting = | Two hands texting = |
| | trueDeletion rate = | trueDeletion rate = | falseDeletion rate = | falseDeletion rate = |
| | 0.1 per wordSurface | 0.2 per wordSurface | 0.3 per wordSurface | 0.4 per wordSurface |
| | area (average 5 | area (average 5 | area (average 5 | area (average 5 |
| | seconds) = 88 mm2 | seconds) = 71 mm2 | seconds) = 112 mm2 | seconds) = 137 mm2 |
| | Touch time | Touch time | Touch time | Touch time |
| | (average per key) = | (average per key) = | (average per key) = | (average per key) = |
| | 112 ms | 85 ms | 134 ms | 152 ms |
| Light Sensor | Average light level | Average light level | Average light level (5 | Average light level (5 |
| | (5 seconds) that | (5 seconds) that | seconds) that light | seconds) that light |
| | light sensor detects = | light sensor detects = | sensor detects = 245 | sensor detects = 212 |
| | 314 lumens | 344 lumens | lumens | lumens |
| Bluetooth | Connected | Connected | Connected Bluetooth = 1 | Connected Bluetooth = 1 |
| | Bluetooth = none | Bluetooth = none | | |
| Other phones | Available Bluetooth = 3 | Available Bluetooth = 2 | Available Bluetooth = 1 | Available Bluetooth = 2 |
| nearby | | | | |
| Communicating | Car sensor = Not | Car sensor = Not | Car sensor = Not | Car sensor = Driver |
| with the car | avaialable | avaialable | avaialable | only |
| Voice/speech? | Conversating in last | Conversating in last | Conversating in last 5 | Conversating in last 5 |
| | 100 minutes = 0.2 | 100 minutes = 0.4 | minutes = 0 | minutes = 0 |
| | conversations | conversations | conversations | conversations |
| Face and | Face attributes | Not applicable | Common face | Different than safe- |
| behavior | baseline for person 1 | | characteristics of text | texting attributes of |
| analytics | | | and drivers. | Person 1, i.e. eye |
| | | | | brows raised |
| | | | | significantly more |
| | | | | times than safe |
| | | | | texting time. |

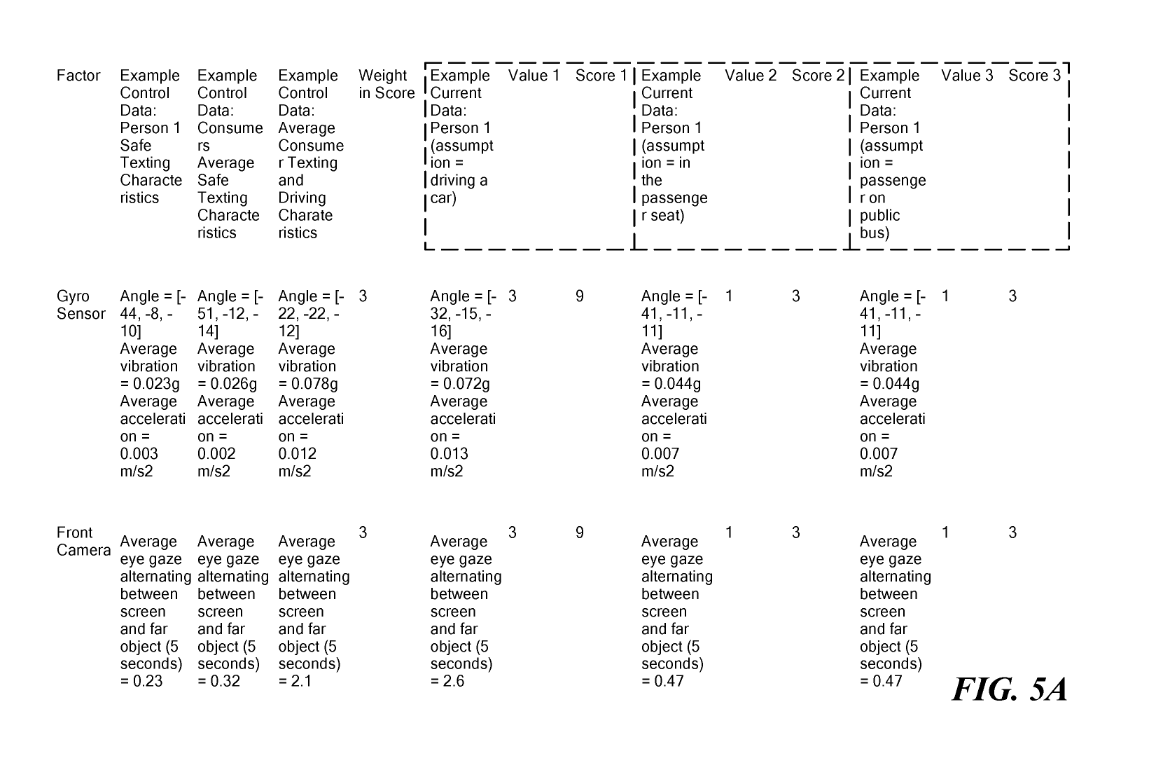

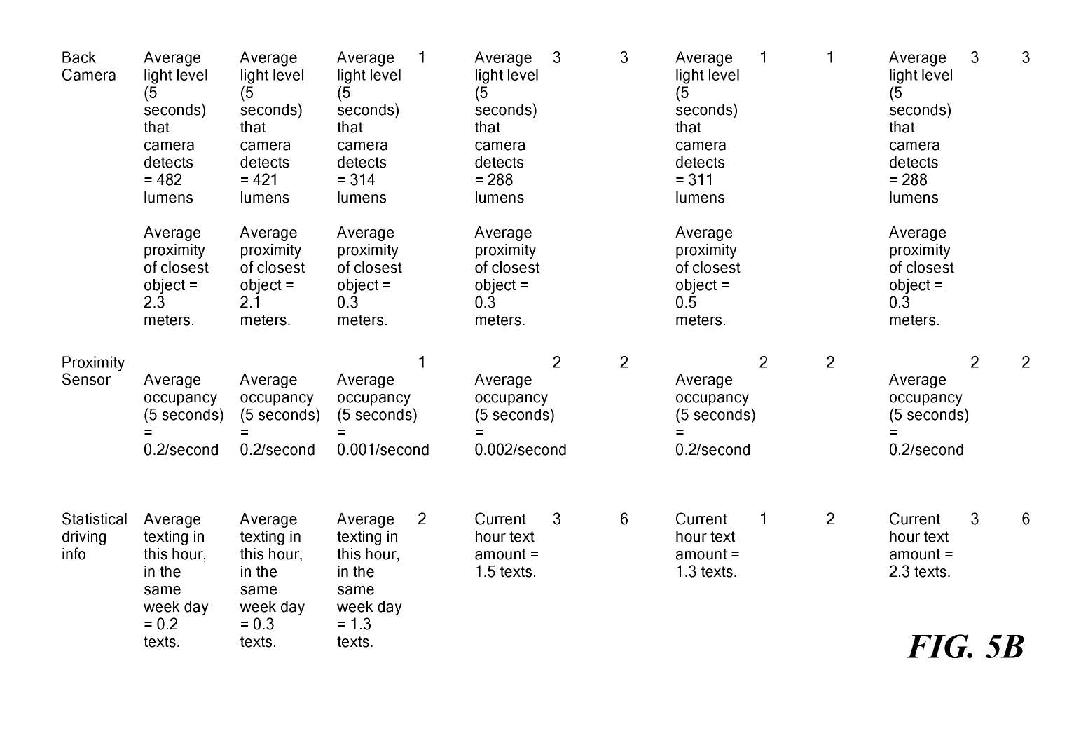

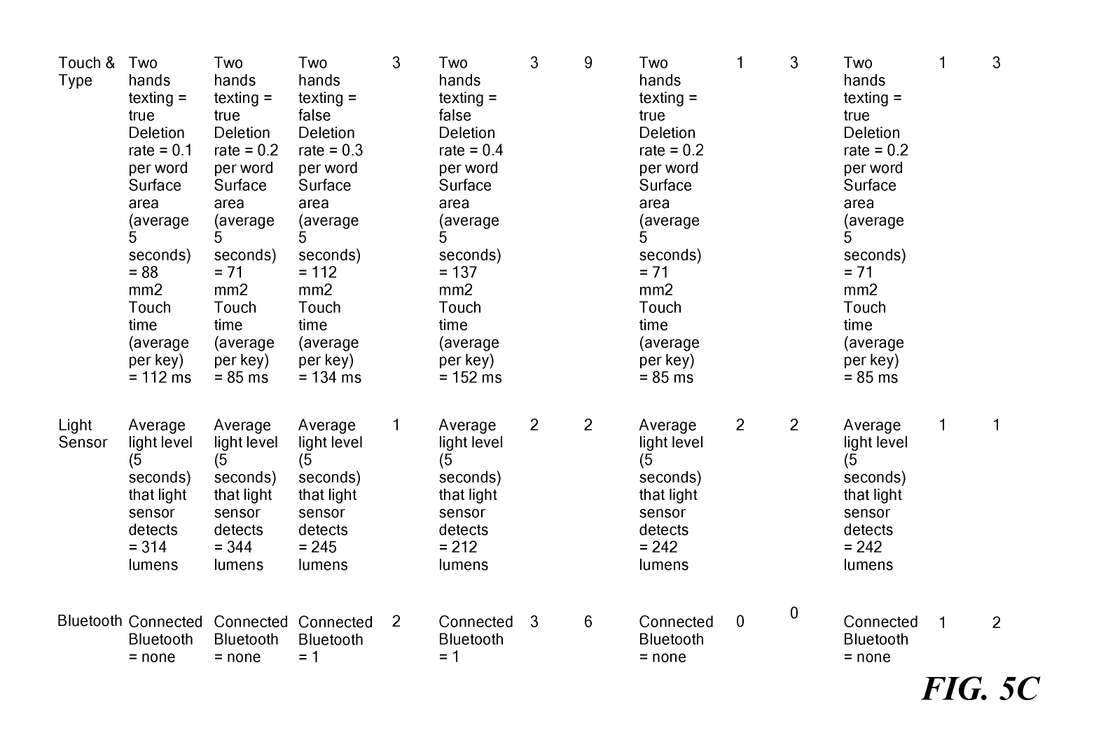

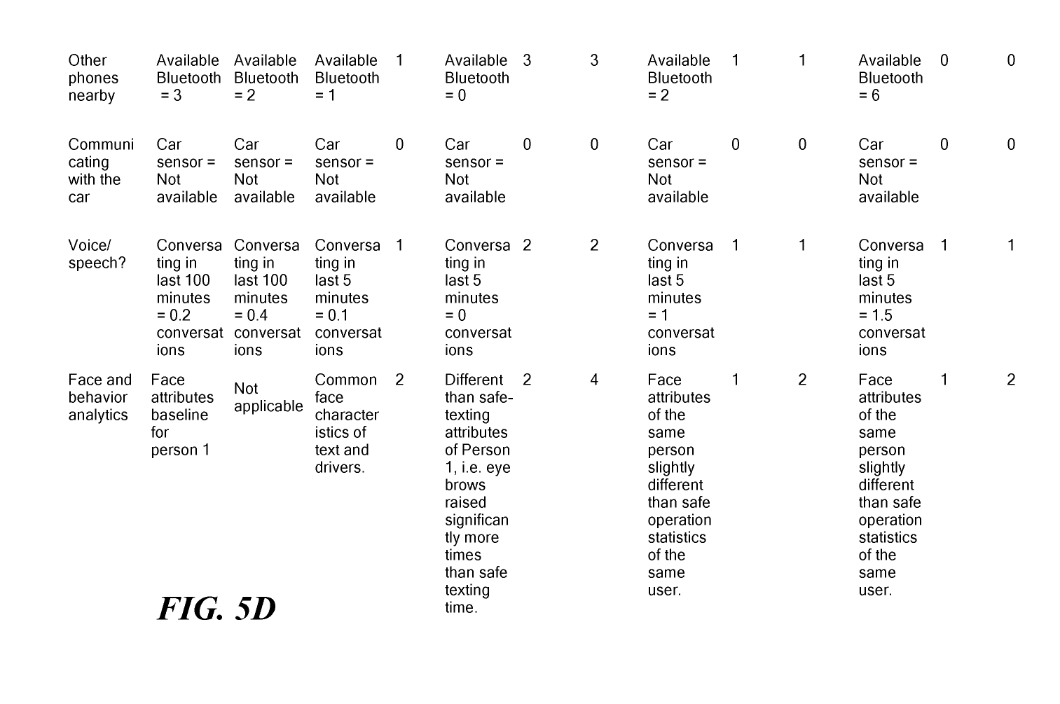

The above data is shown in FIGS. 5A-5D with the addition of a value column (Value 1, Value 2, Value) indicating an example weight for the particular sensor data. Example weighting values in include 1, 2, and 3, where 3 is more heavily weighted than a 1. In example embodiments, sensor data with a Value of 3 are more heavily weight than 2 or 3. For example, gyro sensor data has a weighing value of 3 for the highest weighting value in the example embodiment. It is understood that any practical weighting technique can be used to meet the needs of a particular application.

A score column (Score 1, Score 2, Score 3) is also added in FIGS. 5A-5D. The score provides a relative value for the sensor data indicative of the likelihood of a distracted driving condition. That is, each score can be high or low depending upon the likelihood of a drive and text condition. Distracted driving scores of 55, 20, and 16 derived from the score and weighting values are shown in FIG. 5D. As will be appreciated, the score of 55 is indicative of a texting and driving situation.

In embodiments, distraction detection module 126 uses available sensor data, statistics of current and aggregated users, and/or criteria rules to generate a distracted driving score. In one embodiment, the higher the score, the more likely there is a text and driving situation. The score calculation method may be updated by machine learning for higher accuracy and efficiency, and thus reduce false positives and negatives. Each criteria element, such as data from gyro-accelerator sensor 130, may have a specific weight in the score calculation. This weight may be updated by machine learning. Each criteria element has a specific value indicating the likeliness of distracted driving which is achieved by comparing the current sensor data with reference values like safe and unsafe condition baselines of the same user, and safe and unsafe condition baselines of all users aggregated.

For illustration purposes, below is an example showing how a score indicating the likelihood of a distracted driving situation may be computed, using two criteria elements for simplicity:

distracted driving score=sum(each criteria element's value*each criteria element's weight)=sum(front camera value*weight; other devices nearby score*weight)

The front camera value in this example is 3 because user's eyes and head movements indicate he/she is looking at the screen and a far ahead object, alternating more frequently than the safe baseline of the same user and all users aggregated. This indicates a likely driving situation. The other devices nearby score is 3 because there are no nearby devices detected via Bluetooth or similar protocols, indicating the user is likely alone in this moving environment and driving the vehicle.

=sum(3*3;3*1)

=12

Each value is normalized with a desired weight, in this example multiplied. It is understood that weights can be implemented in any suitable way. In example embodiments, weighted values are summed to generate a total score. In this example, 12 is a sufficiently high score so as to be indicative of texting and driving.

One can take another example using the similar logic:

distracted driving score=sum(front camera value*weight; other devices nearby score*weight)=sum(1*3;0*1)=3

This time the front camera value is 1 because user's eye and head movement is only slightly different than safe operation baseline of the same users and aggregated users. The other devices nearby score is 0 (zero) because there are 6 other devices nearby that broadcast Bluetooth signals. This user is likely in a public transportation and not texting and driving. The score in this case is 3 which is significantly lower than 12 in the previous example. If this user in the public transportation was the bus driver, the score would have been 9 due to high eye and head movements score, which as well would indicate a likely text and driving situation.

In cases where only some of the sensor data is available, the distraction detection module can dynamically adjust the weight and score calculations to accommodate the missing sensor data in order to achieve accuracy.

A further example is shown in Table 1 below. Columns G and J are current data points that the distraction detector compares against data in columns C, D, and E which are statistical reference points (control group). Column G has the current (angle, vibration, and acceleration) values and they are different than the values in columns C and D (non-texting characteristics), and closer to column E (average text-and-drive characteristics). In general, during text-and-drive situations, the driver holds the phone in a different angle to accommodate steering wheel obstruction and positions the device as that the device is not too far from the road view. Also, due to multitasking, driver changes the angle of the phone several times causing high average acceleration. As a result, a relatively high score indicative of driving and texting is generated.

If we put the same person in the passenger seat this time, the values in column J are not expected to differ too much from column C and D, as a result it scores low.

TABLE 1

| | | C | D | E | | | | | J | | |
|---|---|---|---|---|---|---|---|---|---|---|---|
| | | Example | Example | Example | | G | | | Example | | |
| | | Control Data: | Control Data: | Control Data: | | Example | | | Current Data: | | |
| | | Person 1 | Consumers | Average Consumer | | Current Data: | | | Person 1 | | |
| | | Safe | Average Safe | Texting and | F | Person 1 | H | I | (assumption = | K | L |
| A | B | Texting | Texting | Driving | Weight | (assumption = | Value | Score | in the passenger | Value | Score |
| Factor | Logic | Characteristics | Characteristics | Characteristics | in Score | driving a car) | 1 | 1 | seat) | 2 | 2 |

| | | | | | | | | | | |
|---|---|---|---|---|---|---|---|---|---|---|
| Gyro | Angle = | Angle = | Angle = | 3 | Angle = | 3 | 9 | Angle = | 1 | 3 |
| Sensor | [−44, −8, −10] | [−51, −12, −14] | [−22, −22, −12] | | [−32, −15, −16] | | | [−41, −11, −11] | | |
| | Average | Average | Average | | Average | | | Average | | |
| | vibration = | vibration = | vibration = | | vibration = | | | vibration = | | |
| | 0.023 g | 0.026 g | 0.078 g | | 0.072 g | | | 0.044 g | | |
| | Average | Average | Average | | Average | | | Average | | |
| | acceleration = | acceleration = | acceleration = | | acceleration = | | | acceleration = | | |
| | 0.003 m/s2 | 0.002 m/s2 | 0.012 m/s2 | | 0.013 m/s2 | | | 0.007 m/s2 | | |

In embodiments, the weight of each data point and score calculation logic may be updated by a machine learning module. In embodiments, the weight of gyro sensor (gyro-accelerometer) is high because most users hold their devices differently when they text and drive than in a stationary environment, such as texting on a couch. However, machine learning may update the weight to achieve higher accuracies. In embodiments, the weight of voice/speech is low because it may have high error rates as the device may inaccurately determine that there are two people talking in the vehicle, which would decrease the possibility of text and drive, however, such audio may be generated by two people talking on the radio, for example.

An example weighting and priority configuration is set forth below:

| | Weight |
|---|---|
| Sensor data | in Score |
| Gyro Sensor | 3 |
| Front Camera | 3 |
| Touch & Type | 3 |
| Statistical driving info | 2 |
| Bluetooth | 2 |
| Face and behavior analytics | 2 |
| Back Camera | 1 |
| Proximity Sensor | 1 |
| Light Sensor | 1 |
| Other phones nearby | 1 |
| Voice/speech? | 1 |
| Communicating with the car | 0 |

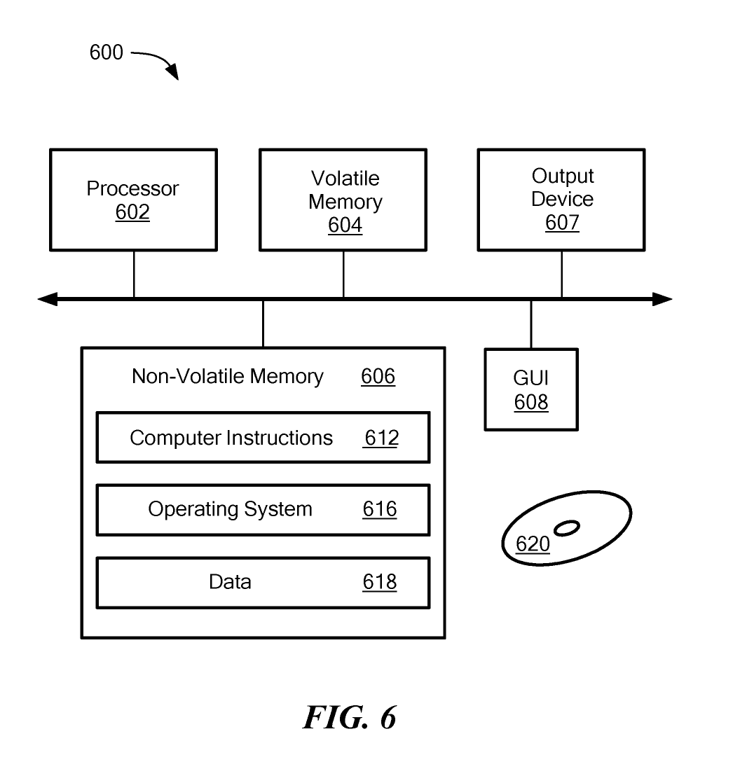

FIG. 6 shows an exemplary computer 600 that can perform at least part of the processing described herein. The computer 600 includes a processor 602, a volatile memory 604, a non-volatile memory 606 (e.g., hard disk), an output device 607 and a graphical user interface (GUI) 608 (e.g., a mouse, a keyboard, a display, for example). The non-volatile memory 606 stores computer instructions 612, an operating system 616 and data 618. In one example, the computer instructions 612 are executed by the processor 602 out of volatile memory 604. In one embodiment, an article 620 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The score calculation may be done locally on the handheld device or by a remote computer such as cloud computing.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
receiving sensor information including GPS data to determine whether a computing device under control of a user is moving relative to Earth surface;
receiving sensor information including vibration levels of the device;
receiving sensor information including angle orientation information for the device;
receiving sensor information including first camera information for the device to detect at least one of user head and eye movement;
processing the sensor information to determine a score corresponding to a likelihood of a distracted user condition; and
communicating with a keyboard module of the device to modify at least one setting for operation of a keyboard controlled by the keyboard module, the communicating including providing the keyboard module with at least one of (i) an indication of a distracted user condition (ii) the score corresponding to the likelihood of a distracted user condition.

2. The method according to claim 1, further including receiving sensor information including data from a first camera of the device and processing eye movement of the user.

3. The method according to claim 1, further including receiving sensor information including touch and type information for a user typing on the keyboard of the device.

4. The method according to claim 3, further including processing the touch and type information to determine whether the user is one-hand typing or two-hand typing on the keyboard.

5. The method according to claim 3, further including processing the touch and type information for error rate comparison.

6. The method according to claim 3, further including processing the touch and type information for finger surface area on the keyboard.

7. The method according to claim 3, further including processing the touch and type information for speed of typing comparison.

8. The method according to claim 1, further including processing historical driving information for the user including time of day historical driving information.

9. The method according to claim 1, further including receiving sensor information including local wireless connection information.

10. The method according to claim 1, further including receiving sensor information including second camera information from the device that includes light level.

11. The method according to claim 1, further including receiving sensor information including data from a proximity sensor of the device.

12. The method according to claim 1, further including receiving sensor information including data from a light sensor of the device.

13. The method according to claim 1, further including receiving sensor information including data for a number of other nearby devices.

14. The method according to claim 1, further including receiving sensor information including acoustic information detected by the device to determine a number of persons in a vehicle.

15. The method according to claim 1, further including receiving sensor information including face and behavior information of the user.

16. The method according to claim 1, further including generating a signal for an audible alert corresponding to the score corresponding to a likelihood of a distracted user condition being above a selected threshold.

17. The method according to claim 1, wherein modifying at least one setting for operation of a keyboard controlled by the keyboard module including disabling the keyboard.

18. An article, comprising:
a non-transitory computer-readable medium having stored instructions that enable a machine to perform:
receiving sensor information including GPS data to determine whether a computing device under control of a user is moving relative to Earth surface;
receiving sensor information including vibration levels of the device;
receiving sensor information including angle orientation information for the device;
receiving sensor information including first camera information for the device to detect at least one of user head and eye movement;
processing the sensor information to determine a score corresponding to a likelihood of a distracted user condition; and
communicating with a keyboard module of the device to modify at least one setting for operation of a keyboard controlled by the keyboard module, the communicating including providing the keyboard module with at least one of (i) an indication of a distracted user condition and (ii) the score corresponding to the likelihood of a distracted user condition.

19. A device, comprising:
a processor and a memory, the processor being configured to:
receiving sensor information including GPS data to determine whether the device is moving relative to Earth surface;
receiving sensor information including vibration levels of the device;
receiving sensor information including angle orientation information for the device;
receiving sensor information including first camera information for the device to detect at least one of user head and eye movement;
generating a score corresponding to a likelihood of a distracted user condition based on the received sensor information; and
in response to detecting that the score corresponding to the likelihood of a distracted user condition exceeds a threshold, providing a keyboard module with at least one of (i) an indication of a distracted user condition and (ii) the score corresponding to the likelihood of a distracted user condition,
wherein the keyboard module is configured to modify at least one setting for operation of a keyboard controlled by the keyboard module based on the score corresponding to the likelihood of a distracted user condition.
